(19) United States
(12) Patent Application Publication
(10) Pub. No.: US 2026/0063216 A1
(43) Pub. Date: Mar. 5, 2026

(54) CHECK VALVE

(71) Applicant: TOYOTA JIDOSHA KABUSHIKI KAISHA, Toyota-shi (JP)

(72) Inventor: Junpei SHOUJI, Toyota-shi (JP)

(73) Assignee: TOYOTA JIDOSHA KABUSHIKI KAISHA, Toyota-shi (JP)

(21) Appl. No.: 19/176,287

(22) Filed: Apr. 11, 2025

(30) Foreign Application Priority Data
Sep. 2, 2024 (JP) 2024-150871

(51) Int. Cl. F16K 15/14

(52) U.S. Cl. CPC F16K 15/148

(57) ABSTRACT

A check valve comprising: a first member having a first surface; a second member having a second surface opposed to the first surface of the first member; and a valve body provided between the first surface and the second surface, wherein the valve body contacts the first surface to block a flow path of a fluid, the valve body contacts the second surface to open the flow path, and the second surface has a tapered shape in a direction from the first member toward the second member, and when a flow rate of the fluid is small, a tip portion of the valve body contacts the second surface, and when a flow rate of the fluid is large, the valve body has a shape along the tapered shape of the second surface.

### CROSS-REFERENCE TO RELATED APPLICATION

This application claims priority to Japanese Patent Application No. 2024-150871 filed on September 2, 2024. The disclosure of the above-identified application, including the specification, drawings, and claims, is incorporated by reference herein in its entirety.

### BACKGROUND

### Technical Field

The present disclosure relates to a check valve.

### Description of Related Art

A check valve may be provided in a flow path of a fluid (for example, Japanese Unexamined Patent Application Publication No. 2008-045698 (JP 2008-045698 A)).

### SUMMARY

As the valve body of the check valve deforms, the check valve is opened and closed. When the valve is opened, the valve body comes into contact with a stopper, and the flow path is opened. Turbulence may occur in the fluid. The turbulence generates a force that causes the valve body to float from the stopper. Such a force may cause the valve body to vibrate and generate abnormal noise. Therefore, an object of the present disclosure is to provide a check valve that can suppress vibration of the valve body.

The above object can be achieved by a check valve including:

a first member including a first surface;

a second member including a second surface facing the first surface of the first member; and

a valve body provided between the first surface and the second surface.

The valve body is configured to come into contact with the first surface to close a flow path of a fluid.

The valve body is configured to come into contact with the second surface to open the flow path.

The second surface has a tapered shape in a direction from the first member to the second member.

When a flow rate of the fluid is small, a tip portion of the valve body is in contact with the second surface.

When the flow rate of the fluid is large, the valve body has a shape conforming to the tapered shape of the second surface.

The flow path of the fluid may be located between the first surface and the second surface.

The second member may have a hole extending through the second member in a direction from the second member to the valve body.

The second member may have a slit on the second surface, and the slit may function as the flow path of the fluid.

The valve body may be made of rubber.

It is possible to provide the check valve that can suppress the vibration of the valve body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view illustrating a check valve according to a first embodiment;

FIG. 2A is an enlarged cross-sectional view of a valve body;

FIG. 2B is an enlarged cross-sectional view of the valve body; and

FIG. 3 is a cross-sectional view illustrating a check valve according to a second embodiment.

### DETAILED DESCRIPTION OF EMBODIMENTS

### First Embodiment

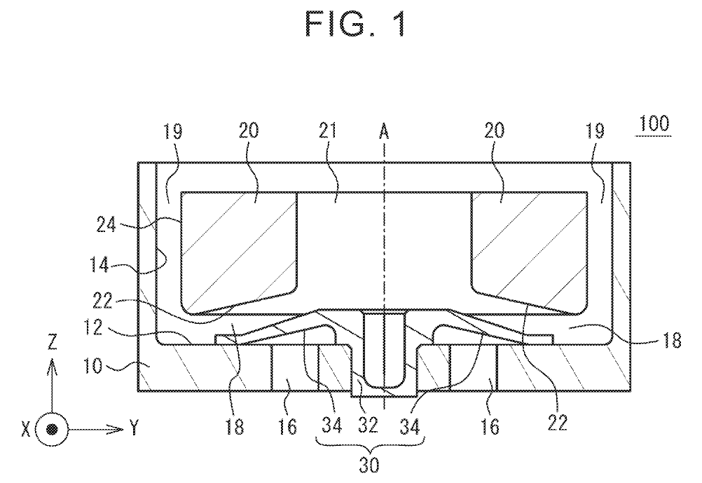

Hereinafter, a control device for a vehicle according to the present embodiment will be described with reference to the drawings. FIG. 1 is a cross-sectional view illustrating the check valve 100 according to the first embodiment, and illustrates a state in which the check valve 100 is closed. The axis A is a central axis of the check valve 100 in the Z-axis direction. The check valve 100 is, for example, rotationally symmetric with respect to the axis A. The X-axis direction, the Y-axis direction, and the Z-axis direction are orthogonal to each other.

A check valve 100 is provided in the fluid flow path. The fluid is, for example, a gas. The check valve 100 includes a housing 10 (first member), a stopper 20 (second member), and a valve body 30.

The housing 10 has a surface 12 (first surface) and a surface 14, and a flow path 16. Surfaces 12 and 14 are surfaces of the inner wall. The surface 12 is parallel to XY plane. The surface 14 is parallel to the Z-axis direction and rises from the surface 12. A space inside the housing 10 is formed in a portion surrounded by the surface 12 and the surface 14. The stopper 20 and the valve body 30 are housed in a space inside the housing 10. The flow path 16 penetrates the housing 10 in the Z-axis direction, and connects the outside of the housing 10 and the space inside the housing 10.

The stopper 20 has a hole 21, a surface 22 (second surface), and a surface 24. Surfaces 22 and 24 are surfaces of the inner wall. Surface 24 is spaced from surface 14 and faces surface 14. The surface 24 is, for example, parallel to the Z-axis direction. A hole 21 is provided in a central portion of the stopper 20 in XY plane. The hole 21 penetrates the stopper 20 in the Z-axis direction.

Surface 22 is spaced from surface 12 of housing 10 and faces surface 12. The surface 22 is inclined with respect to XY plane and has a tapered shape in the Z-axis direction. The surface 22 is tapered from the surface 12 toward the hole 21. The tilt angle of the surface 22 from XY plane may be, for example, 10° or less, or 10° or more.

A flow path 18 is formed between surface 12 and surface 22. A flow path 19 is formed between the surface 14 and the surface 24. The flow path 16 and the flow path 18 communicate with each other. The flow path 18 and the flow path 19 communicate with each other.

The valve body 30 is made of rubber, for example, and has a shaft 32 and a protrusion 34. The shaft 32 is attached to the housing 10. The protrusion 34 is an umbrella-shaped portion and protrudes outward from the shaft 32. The protrusion 34 is thicker, for example, closer to the shaft 32, and thinner, for example, farther from the shaft 32. The protrusion 34 is elastically deformed in accordance with the pressure of the fluid. Due to the deformation of the protrusion 34, the check valve 100 is closed and opened.

The valve body 30 is, for example, circular in XY plane. As shown in FIG. 1, in the closed state, the valve body 30 has an umbrella shape. The protrusion 34 of the valve body 30 has a shape to hang down toward the housing 10, and is in contact with the surface 12 of the housing 10, and blocks the flow path 18. Fluid flows from the flow path 16 to the inside of the housing 10, but is stopped by the valve body 30.

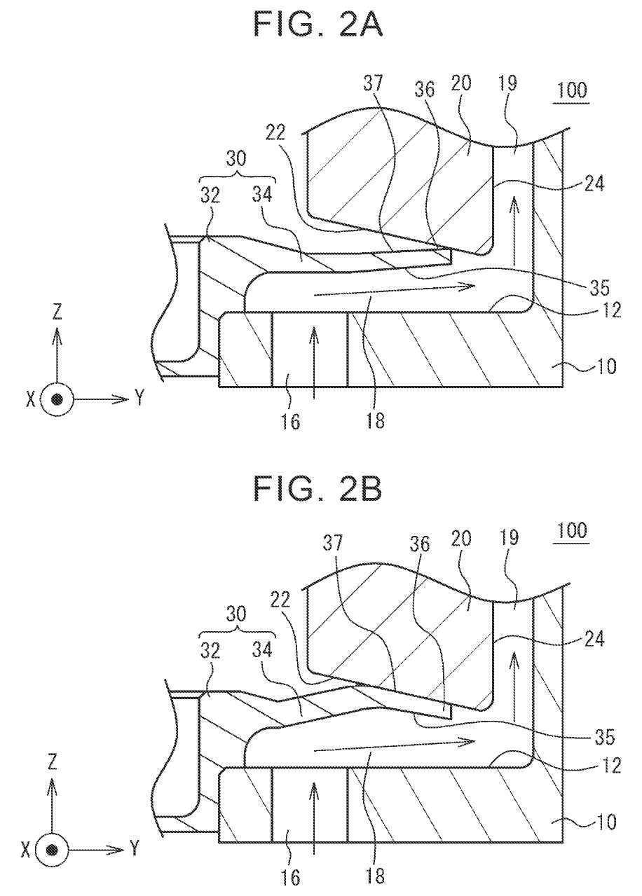

FIGS. 2A and 2B are enlarged cross-sectional views of the valve body 30, illustrating the open valve condition. The surface 35 of the valve body 30 faces the surface 12 of the housing 10. The surface 37 of the valve body 30 is opposite to the surface 35 and faces the surface 22 of the stopper 20. The tip of the protrusion 34 is referred to as a tip portion 36. In the closed state, the tip portion 36 contacts the surface 12 of the housing 10. Surfaces 35 and 37 are exposed to fluid.

As shown in FIGS. 2A and 2B, the protrusion 34 of the valve body 30 is deformed upward in the drawing. The protrusion 34 is spaced apart from the housing 10 and moves toward the stopper 20. The stopper 20 restricts the movement of the protrusion 34. When the protrusion 34 comes into contact with the surface 22 of the stopper 20, the flow path 18 opens and the check valve 100 opens. The fluid flows through the flow path 16, the flow path 18, and the flow path 19.

The flow rate of the fluid in FIG. 2A is greater than the flow rate in FIG. 1 and less than the flow rate in FIG. 2B. In FIG. 2A, the tip portion 36 of the protrusion 34 contacts the surface 22 of the stopper 20. Surfaces 35 and 37 of protrusion 34 are exposed to fluid.

The pressure upstream of the flow path is higher than the pressure downstream. A part of the fluid flowing through the flow path 19 flows into the hole 21 of the stopper 20. The pressure in the hole 21 is about the same as the pressure in the flow path 19. The pressure in the flow path 16 and the flow path 18 is higher than the pressure in the flow path 19 and the hole 21.

Pressure is applied to the surface 35 of the valve body 30 at the same level as the pressure applied to the flow path 18. The surface 37 is subjected to the same pressure as the inside of the hole 21 of the stopper 20. Since the pressure applied to the surface 37 is lower than the pressure applied to the surface 35, a differential pressure is generated. The differential pressure causes the valve body 30 to move toward the stopper 20. Since the surface 22 of the stopper 20 has a tapered shape, a space is formed between the surface 37 and the surface 22 of the valve body 30, the surface 37 is exposed, and the pressure receiving area is increased. Thus, the protrusion 34 is susceptible to differential pressure. Continuing to receive the differential pressure maintains the protrusion 34 in FIG. 2A. In other words, the valve body 30 hardly vibrates, and the tip portion 36 stably contacts the surface 24.

The flow rate in FIG. 2B is greater than the flow rate in FIG. 2A. As the flow rate increases, the pressure experienced by the surface 35 of the valve body 30 increases. Since the surface 22 of the stopper 20 has a tapered shape, the protrusion 34 is further deformed in the Z-axis direction and has a shape along the surface 22. That is, the protrusion 34 has a wedge shape protruding in the Z-axis direction. Surface 37 contacts surface 22 of stopper 20. Fluid in the flow path 18 presses the wedge-shaped protrusion 34 against the surface 22. Therefore, the valve body 30 is stabilized, and the valve body is hardly swung.

According to the first embodiment, a flow path 18 is formed between the surface 12 of the housing 10 and the surface 22 of the stopper 20. When the valve body 30 comes into contact with the surface 22, the flow path 18 opens, and the check valve 100 opens. Since the surface 22 has a tapered shape, the valve body 30 is deformed in accordance with the flow rate of the fluid. The deflection of the protrusion 34 of the valve body 30 can be suppressed.

Specifically, when the flow rate is low as in FIG. 2A, the tip portion 36 of the protrusion 34 contacts the surface 22. Surface 37 of protrusion 34 does not contact surface 22 and is exposed to fluid. The area of the valve body 30 that receives the differential pressure (pressure receiving area) increases. The valve body 30 is stable in a deformed state and is less likely to shake.

As shown in FIG. 2B, as the flow rate of the fluid is increased relative to that of the example in FIG. 2A, the protrusion 34 deforms into a wedge shape along the tapered shape of the surface 22. When the flow velocity of the fluid increases, turbulence is likely to occur. According to the first embodiment, the valve body 30 is pressed against the surface 22 by the fast flowing fluid and deforms along the tapered shape. Since the protrusion 34 is pressed against the surface 22, the valve body 30 is stabilized in a deformed state. That is, since the valve body 30 maintains the configuration shown in FIG. 2B, the valve body 30 is less likely to vibrate. The deflection of the valve body 30 can be suppressed, and abnormal noise caused by vibration is unlikely to be generated.

As shown in FIG. 1, the stopper 20 has a hole 21. Pressure is applied to the surface 37 of the valve body 30 at the same level as the inside of the hole 21 of the stopper 20. The pressure applied to the surface 35 is the same as the pressure applied to the flow path 18. The differential pressure maintains the shape of the valve body 30. The valve body 30 is less likely to vibrate.

Since the valve body 30 is made of rubber, it is easily deformed by the pressure of the fluid. As shown in FIGS. 1 to 2B, the protrusion 34 of the valve body 30 is deformed into an umbrella shape, a near-horizontal shape, and a wedge shape along the surface 22. Check valve 100 can be closed and opened.

### Second Embodiment

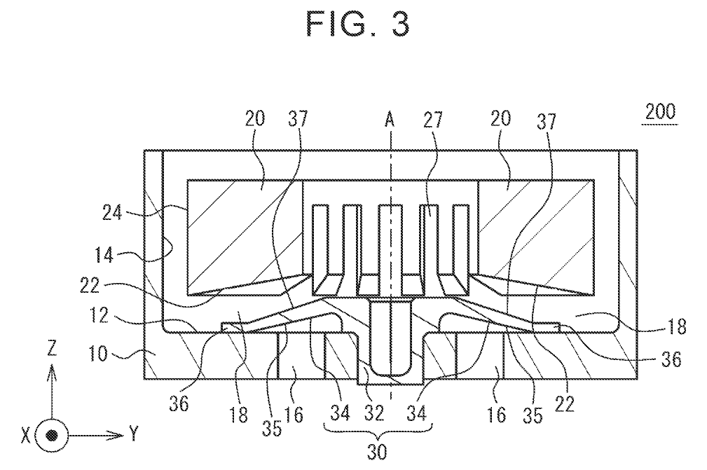

FIG. 3 is a cross-sectional view illustrating the check valve 200 according to the second embodiment. Description of the same configuration as in the first embodiment will be omitted. The stopper 20 has a plurality of slits 27. The plurality of slits 27 are provided radially in XY plane. The slit 27 extends from the surface 22 in the Z-axis direction and functions as a fluid flow path.

FIG. 3 illustrates a closed state. The protrusion 34 of the valve body 30 hangs down in an umbrella shape. The fluid is rubbed by the valve body 30 before the slit 27. Therefore, no fluid flows. When the protrusion 34 is deformed upward, the tip portion 36 of the valve body 30 comes into contact with the surface 22 of the stopper 20. A slit 27 communicates with the flow path 16 and fluid flows through the slit 27. That is, the check valve 100 is opened. As the flow rate increases further, the protrusion 34 deforms into a wedge shape and the surface 37 contacts the surface 22.

According to the second embodiment, the slit 27 of the stopper 20 functions as a flow path. Since the surface 22 has a tapered shape, the valve body 30 is deformed in accordance with the flow rate of the fluid. The deflection of the protrusion 34 of the valve body 30 can be suppressed.

The check valve has flow paths 18 and 19 between the housing 10 and the stopper 20 and may have a slit 27.

Although the preferred embodiment of the disclosure is described above in detail, the disclosure is not limited to the specific embodiment, and various modifications and changes may be made within the scope of the disclosure described in claims.

What is claimed is:

1. A check valve comprising:
a first member including a first surface;
a second member including a second surface facing the first surface of the first member; and
a valve body provided between the first surface and the second surface, wherein
the valve body is configured to come into contact with the first surface to close a flow path of a fluid,
the valve body is configured to come into contact with the second surface to open the flow path,
the second surface has a tapered shape in a direction from the first member to the second member,
when a flow rate of the fluid is small, a tip portion of the valve body is in contact with the second surface, and
when the flow rate of the fluid is large, the valve body has a shape conforming to the tapered shape of the second surface.

2. The check valve according to claim 1, wherein the flow path of the fluid is located between the first surface and the second surface.

3. The check valve according to claim 2, wherein the second member has a hole extending through the second member in a direction from the second member to the valve body.

4. The check valve according to claim 1, wherein:
the second member has a slit on the second surface; and
the slit functions as the flow path of the fluid.

5. The check valve according to claim 1, wherein the valve body is made of rubber.
